(19) United States
(12) Patent Application Publication
(10) Pub. No.: US 2022/0009102 A1
(43) Pub. Date: Jan. 13, 2022

(54) ROBOTIC ASSEMBLY CELL

(71) Applicant: DIVERGENT TECHNOLOGIES, INC., Los Angeles, CA (US)

(72) Inventors: Lukas Philip Czinger, Los Angeles, CA (US); Aron Derecichei, Los Angeles, CA (US)

(21) Appl. No.: 16/926,584

(22) Filed: Jul. 10, 2020

(51) Int. Cl. B25J 9/16

(52) U.S. Cl. CPC B25J 9/1669; B25J 9/1617; B25J 9/1687

(57) ABSTRACT

In an aspect of the disclosure, a first manufacturing cell for assembling a structure is provided. The first manufacturing cell for assembling the structure may include a plurality of first robots positioned around a common point in a first configuration, and a plurality of second robots positioned around the common point in a second configuration, the second configuration being closer to the common point than the first configuration. One of the plurality of first robots is configured to translate towards and away from the common point to interact with one of the plurality of second robots or one of the plurality of second robots is configured to translate towards and away from the common point to interact with one of the plurality of first robots.

### BACKGROUND

### Technical Field

The present disclosure relates generally to robotic systems and apparatuses, and more particularly, to configurations of assembly cells that include robotic apparatuses.

### Introduction

A vehicle such as an automobile, truck or aircraft is made of a large number of individual structural components joined together to form the body, frame, interior and exterior surfaces, etc. These structural components provide form to the automobile, truck and aircraft, and respond appropriately to the many different types of forces that are generated or that result from various actions like accelerating and braking. These structural components also provide support. Structural components of varying sizes and geometries may be integrated in a vehicle, for example, to provide an interface between panels, extrusions, and/or other structures. Thus, structural components are an integral part of vehicles.

Most structural components must be joined with another part, such as another structural component, in secure, well-designed ways. Modern vehicle factories rely heavily on robotic assembly of structural components. However, robotic assembly of vehicular components requires the use of an assembly line, fixtures, and other similar features. Such features in conventional vehicular assembly are generally statically configured. In automobile factories, for example, each part of the automobile that will be robotically assembled requires a unique fixture that is specific to that part. Additionally, each robot is configured to use a single fixture at a single location. Each robot uses a respective fixture to add one type of part to a semi-finished assembly as the semi-finished assembly moves from robot to robot in according to a fixed sequence.

Sequentially adding parts to an assembly as the assembly moves down the line requires that the assembly remain at the workstation of a robot for an appreciable amount of time, e.g., as each robot adds a respective part at each workstation. Furthermore, only one type of assembly is produced according to a configuration of a line. Given the substantial cost to produce an assembly, configuring a line to produce only one type of assembly for mass production is the only economically feasible option.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Conventional vehicular manufacturing systems rely on assembly lines including multiple robots that each has a respective fixture configured for attaching a respective part to an assembly. These fixtures are specific to the design of the corresponding part. The assembly travels down the line and receives a respective part from each robot in sequence. However, a need exists for improvements to modern vehicular assembly. Such improvements may be more economical, both in terms of time and capital. For example, such improvements may allow for production of different vehicles and assemblies using the same robots in a manner that is practical both in terms of time and in investment. The present disclosure provides for more robust and dynamic approaches to vehicular assembly that are different from conventional assembly lines that include multiple robots with multiple fixtures.

In particular, the present disclosure describes various techniques and solutions to configuring manufacturing cells with robots that are able to interact for assembly operations that are fixtureless. Such assembly operations may include joining two or more structures (e.g., additively manufactured structures such as nodes), parts, components, and the like. In joining multiple structures, at least a portion of a vehicle may be assembled. For example, joining multiple structures may result in assembly of at least a portion of a body, frame, chassis, panel, etc. of a vehicle and other multi-part structure.

Advantageously, aspects of manufacturing cells described herein include robots that are able to translate in order to join structures, e.g., as opposed to an assembly that moves down a line as parts are added. Such translation may be beneficial in terms of space and time. Furthermore, different types and configurations of structures may be joined, e.g., through fixtureless configurations of robots and/or translation of robots in manufacturing cells. Thus, the aspects of manufacturing cells described herein may offer space, time, and/or cost improvements over conventional vehicular manufacturing systems.

In an aspect of the disclosure, a first manufacturing cell for assembling a structure is provided. The first manufacturing cell for assembling the structure may include a plurality of first robots positioned around a common point in a first configuration, and a plurality of second robots positioned around the common point in a second configuration, the second configuration being closer to the common point than the first configuration. One of the plurality of first robots is configured to translate towards and away from the common point to interact with one of the plurality of second robots or one of the plurality of second robots is configured to translate towards and away from the common point to interact with one of the plurality of first robots.

In a second aspect of the first manufacturing cell, at least the plurality of first robots are equidistant from the common point in the first configuration or at least the plurality of second robots are equidistant from the common point in the second configuration. In a third aspect of the first manufacturing cell, the plurality of first robots are fixedly positioned in the first configuration when the plurality of second robots translate towards and away from the common point, or the plurality of second robots are fixedly positioned in the second configuration when the plurality of first robots translate towards and away from the common point. In a fourth aspect of the first manufacturing cell, the plurality of first robots comprise a material handling robot configured to pick and join parts of a structure and an adhesive dispensing and a curing robot configured to adhere the parts together, and the plurality of second robots comprise a material handling and curing robot configured to pick, join, and adhere parts together to form subassemblies when assembling the structure.

In a fifth aspect of the first manufacturing cell, the first manufacturing cell further comprises a central robot located at the common point and configured to receive the subassemblies from the plurality of second robots. In a sixth aspect of the first manufacturing cell, the plurality of first robots and the plurality of second robots are divided within separate zones for simultaneously assembling different parts to form the subassemblies. In a seventh aspect of the first manufacturing cell, one of the plurality of first robots or one of the plurality of second robots is configured to translate across the separate zones. In an eighth aspect of the first manufacturing cell, each zone comprises a first subzone and a second subzone, the plurality of second robots comprises a material handling robot and a curing robot, the material handling robot is diagonally opposed to one of the plurality of first robots within either the first subzone or the second subzone, and the curing robot is diagonally opposed to another of the plurality of first robots within both the first subzone and the second subzone.

In a ninth aspect of the first manufacturing cell, the plurality of first robots comprise a plurality of material handling robots and a plurality of adhesive dispensing and curing robots, and wherein the plurality of material handling robots and the plurality of adhesive dispensing and curing robots are alternately arranged in the first configuration. In a tenth aspect of the first manufacturing cell, the adhesive dispensing and curing robot is configured to switch from an adhesive end-effector to a curing end-effector while the material handling robot is applying a move-measure-correct procedure. In an eleventh aspect of the first manufacturing cell, the material handling and curing robot is configured to switch between a material handling end-effector and a curing end-effector based on the subassemblies being assembled. In a twelfth aspect of the first manufacturing cell, one or more pairs of part tables movably positioned at a perimeter of the manufacturing cell for access by the material handling robot and the material handling and curing robot, and one table in each pair is accessible for the parts while the other table in each pair is being reloaded with different parts.

In another aspect of the disclosure, a second manufacturing cell for assembling a structure is provided. The second manufacturing cell for assembling the structure may include a first set of robots arranged along a perimeter of a first shape, and a second set of robots arranged along a perimeter of a second shape within the first shape, and at least one of the robots of the first set of robots is configured to translate along a first path towards and away from the second shape or at least one of the robots of the second set of robots is configured to translate along a second path towards and away from the first shape.

In a second aspect of the second manufacturing cell, the first shape or the second shape is a polygon comprising one of a triangle, a quadrilateral, a pentagon, a hexagon, a heptagon, or an octagon. In a third aspect of the second manufacturing cell, at least the first set of robots are equidistantly positioned along the perimeter of the first shape or at least the second set of robots are equidistantly positioned along the perimeter of the second shape. In a fourth aspect of the second manufacturing cell, the first set of robots are fixedly positioned along the perimeter of the first shape when the second set of robots translate along the second path, or the second set of robots are fixedly positioned along the perimeter of the second shape when the first set of robots translate along the first path.

In a fifth aspect of the second manufacturing cell, the first set of robots comprise a material handling robot configured to pick and join parts of a structure and an adhesive dispensing and curing robot configured to adhere the parts together, and the second set of robots comprise a material handling and curing robot configured to pick, join, and adhere parts together to form subassemblies when assembling the structure. In a sixth aspect of the second manufacturing cell, the second manufacturing cell further comprises a central robot located within the second shape and configured to receive the subassemblies from the second set of robots.

In another aspect of the disclosure, a third manufacturing cell for assembling a structure is provided. The third manufacturing cell for assembling the structure may include a first set of robots arranged along a perimeter of a first shape, a second set of robots arranged along a perimeter of a second shape within the first shape, and a central robot located within the second shape for receiving subassemblies from the second set of robots, and at least one of the robots of the first set of robots is configured to translate along a first path towards and away from the second shape or at least one of the robots of the second set of robots is configured to translate along a second path towards and away from the first shape. In a second aspect of the third manufacturing cell, the first shape or the second shape is a polygon comprising one of a triangle, a quadrilateral, a pentagon, a hexagon, a heptagon, or an octagon.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a perspective view of an example assembly system including an assembly cell, according to various embodiments of the present disclosure.

FIGS. 2A-2C are overhead perspective views of example assembly systems including an assembly cell, according to various embodiments of the present disclosure.

FIGS. 3A-3D are overhead perspective views of other example assembly systems including an assembly cell, according to various embodiments of the present disclosure.

### DETAILED DESCRIPTION

The detailed description set forth below in connection with the appended drawings is intended to provide a description of various exemplary embodiments of the concepts disclosed herein and is not intended to represent the only embodiments in which the disclosure may be practiced. The term “exemplary” used in this disclosure means “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the concepts to those skilled in the art. However, the disclosure may be practiced without these specific details. In some instances, well-known structures and components may be shown in block diagram form, or omitted entirely, in order to avoid obscuring the various concepts presented throughout this disclosure.

According to various aspects of an assembly process, multiple robots are controlled to join two structures together within an assembly cell. The structures may be, for example, nodes, tubes, extrusions, panels, pieces, parts, components, assemblies or subassemblies (e.g., including at least two previously joined structures) and the like. For instance, a structure or a part may be at least a portion or section associated with a vehicle, such as a vehicle chassis, panel, base piece, body, frame, and/or another vehicle component. A node is a structure that may include one or more interfaces used to connect to other structures (e.g., tubes, panels, etc.). The structures may be produced using additive manufacturing (AM) (e.g., 3-D printing).

The assembly operations may be performed repeatedly so that multiple structures may be joined for assembly of at least a portion of a vehicle (e.g., vehicle chassis, body, panel, and the like). A first material handling robot may retain (e.g. using an end effector) a first structure that is to be joined with a second structure similarly retained by a second material handling robot. A structural adhesive dispensing robot may apply structural adhesive to a surface of the first structure retained by the first robot. The first material handling robot may then position the first structure at a joining proximity with respect to the second structure retained by the second material handling robot. A metrology system may implement a move-measure-correct (MMC) procedure to accurately measure, correct, and move the robotic arms of the robots and/or the structures held by the robots into optimal positions at the joining proximity (e.g., using laser scanning and/or tracking).

The positioned structures may then be joined together using the structural adhesive and cured (e.g., over time and/or using heat). However, as the curing rate of the structural adhesive may be relatively long, a quick-cure adhesive robot additionally applies a quick-cure adhesive to the first and/or second structures when the first and second structures are within the joining proximity, and then the quick-cure adhesive robot switches to an end-effector which emits electromagnetic (EM) radiation, such as ultraviolet (UV) radiation, onto the quick-cure adhesive. For example, the quick-cure adhesive robot may apply UV adhesive strips across the surfaces of the first and/or second structures such that the UV adhesive contacts both structures, and then the robot may emit UV radiation onto the applied UV adhesive strips. Upon exposure to the EM radiation, the quick-cure adhesive cures at a faster curing rate than the curing rate of the structural adhesive, thus allowing the first and second structure to be retained in their relative positions so that the robots may quickly attend to other tasks (e.g., retaining and joining other parts) without waiting for the structural adhesive to cure. Once the structural adhesive cures, the first and second structures are bonded with structural integrity.

To provide a more economical approach for robotically assembling a transport structure (e.g., an automobile chassis) without requiring numerous fixtures that are dependent on the chassis design, a fixtureless, non-design specific assembly for structural components may be used. For example, a robot may be configured to directly hold a structure, e.g., using an end effector of a robotic arm, and to position and join that structure with another structure held by another robot during the assembly process. Fixtureless assembly may facilitate various configurations of manufacturing cells described herein.

As described, vehicular assembly may include multiple iterations of discrete sets of operations. For example, two robots may join two structures and, once joined, another robot may apply structural adhesive to the joined structures (which may be a structure itself) and still another robot may apply and cure the quick-cure adhesive. The robots may be relatively agnostic to the structures involved in the assembly operations, e.g., as their engagement and retention of structures may be fixtureless. Thus, an assembly cell in which a set of robots move to accomplish assembly operations is practicable.

Such an assembly cell may be arranged according to a polygon, e.g., rather than an assembly line as with conventional manufacturing processes. For example, an assembly cell of the present disclosure may include sets of robots arranged in a circle, which may be more economical than an assembly line in terms of space and/or cost. Furthermore, with such an arrangement, multiple sets of robots may be configured to operate in parallel, e.g., as opposed to serial operation commensurate with a sequential assembly line.

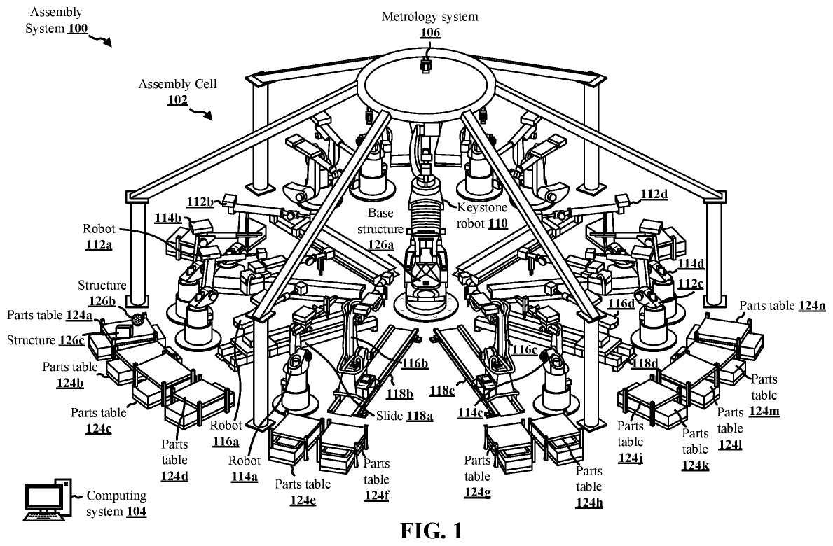

FIG. 1 illustrates a perspective view of an exemplary assembly system 100. In assembly system 100. Assembly system 100 may be employed in various operations associated with assembly of a vehicle, such as robotic assembly of a node-based vehicle. Assembly system 100 may include one or more elements associated with at least a portion of the assembly of a vehicle without any fixtures. For example, one or more elements of assembly system 100 may be configured for one or more operations in which a first structure is joined with one or more other structures without the use of any fixtures during robotic assembly of a node-based vehicle.

An assembly cell 102 may be configured at the location of assembly system 100. Within assembly cell 102, fixtureless assembly system 100 may include a set of robots. A robot 110 that is positioned relatively at the center of assembly cell 102 may be referred to as a “keystone robot.” In some embodiments, keystone robot 110 may be positioned at an approximate center point of assembly cell 102.

Assembly system 100 may include parts tables 124a-n that can hold structures (e.g., parts) for the robots to access. Parts tables 124a-n may be positioned at a periphery or outside of assembly cell 102. For example, parts tables 124a-n may be radially positioned around approximately the outer boundary of assembly cell 102.

Each of parts tables 124a-n may hold any number of structures (e.g., from as few as one structure to more than twenty structures), and may be designed so as to provide access to one or more of the structures at different stages of the assembly process. In some embodiments, one or more of parts tables 124a-n may be restocked during the assembly process. For example, new structures may be added to one or more of parts tables 124a-n in anticipation of future assembly operations as some other assembly operations are occurring.

Illustratively, structures 126b-c may be positioned on a first parts table 124a to be picked up by the robots and assembled together. In various embodiments, each of the structures can weigh at least 10 grams (g), 100 g, 500 g, 1 kilograms (kg), 5 kg, 10 kg, or more. In various embodiments, each of the structures can have a volume of at least 10 milliliter (ml), 100 ml, 500 ml, 1000 ml, 5000 ml, 10,000 ml, or more. In various embodiments, one or more of the structures can be an additively manufactured structure, such as a complex node.

Assembly system 100 may also include a computing system 104 to issue commands to the various controllers of the robots of assembly cell 102. In this example, computing system 104 is communicatively connected to the robots through a wireless communication, although wired connections are also possible. Assembly system 100 may also include a metrology system 106 able to accurately measure the positions of the robotic arms of the robots and/or the structures held by the robots. In some embodiments, metrology system 106 may communicate with computing system 104, e.g., to provide data for MMC processes in which computing system 104 may provide instructions to the controllers of the robots. In example assembly system 100, metrology system 106 can be mounted in a central location above assembly cell 102. In various embodiments, a metrology system may be located, for example, near the perimeter of the assembly cell. Multiple metrology systems can be used in various embodiments, and can be located at various locations within or outside the assembly cell.

In contrast to conventional robotic assembly factories, structures can be assembled without fixtures in assembly system 100. For example, structures need not be connected within any fixtures. Instead, at least one of the robots in assembly cell 102 may provide the functionality expected from fixtures. For example, robots may be configured to directly contact (e.g., using an end effector of a robotic arm) structures to be assembled within assembly cell 102 so that those structures may be engaged and retained without any fixtures. Further, at least one of the robots may provide the functionality expected from the positioner and/or fixture table. For example, keystone robot 110 may replace a positioner and/or fixture table in assembly cell 102.

Keystone robot 110 may include a base and a robotic arm. The robotic arm may be configured for movement, which may be directed by a controller communicatively connected with keystone robot 110 (e.g., computer-executable instructions loaded into a processor of the controller). Keystone robot 110 may contact a surface of assembly cell 102 (e.g., a floor of the assembly cell) through the base.

Keystone robot 110 may include and/or be connected with an end effector that is configured to engage and retain a base structure 126a, e.g., a portion of a vehicle or other build piece. An end effector may be a component configured to interface with at least one structure. Examples of the end effectors may include jaws, grippers, pins, or other similar components capable of facilitating fixtureless engagement and retention of a structure by a robot. Base structure 126a may be a section of a vehicle chassis, body, frame, panel, base piece, and the like. For example, base structure 126a may comprise a floor panel. In some embodiments, base structure 126a may be referred to as an “assembly.”

In some embodiments, keystone robot 110 may retain the connection with base structure 126a through an end effector while a set of other structures is connected (either directly or indirectly) to base structure 126a. Keystone robot 110 may be configured to engage and retain base structure 126a without any fixtures. In some embodiments, structures to be retained by at least one of the robots (e.g., base structure 126a) may be additively manufactured or co-printed with one or more features that facilitate engagement and retention of those structures by the at least one of the robots without the use of any fixtures.

For example, a structure may be co-printed or additively manufactured with one or more features that increase the strength of the structure, such as a mesh, honeycomb, and/or lattice arrangement. Such features may stiffen the structure to prevent unintended movement of the structure during the assembly process. In another example, a structure may be co-printed or additively manufactured with one or more features that facilitates engagement and retention of the structure by an end effector, such as protrusion(s) and/or recess(es) suitable to be engaged (e.g., gripped, clamped, held, etc.) by an end effector. The aforementioned features of a structure may be co-printed with the structure and therefore may be of the same material(s) as the structure.

In retaining base structure 126a, keystone robot 110 may position (e.g., move) base structure 126a; that is, the position of base structure 126a may be controlled by keystone robot 110 when retained thereby. Keystone robot 110 may retain the first structure by “holding” or “grasping” base structure 126a, e.g., using an end effector of a robotic arm of keystone robot 110. For example, keystone robot 110 may retain the first structure by causing gripper fingers, jaws, and the like to contact one or more surfaces of the first structure and apply sufficient pressure thereto such that the keystone robot controls the position of base structure 126a. That is, base structure may 126a be prevented from moving freely in space when retained by keystone robot 110, and movement of base structure 126a may be constrained by keystone robot 110. As described above, base structure 126a may include one or more features that facilitates engagement and retention of base structure 126a by keystone robot 110 without the use of any fixtures.

As other structures (including subassemblies, substructures of structures, etc.) are connected to base structure 126a, keystone robot 110 may retain the engagement with base structure 126a through the end effector. The aggregate of base structure 126a and one or more structures connected thereto may be referred to as a structure itself, but may also be referred to as an “assembly” or a “subassembly.” Keystone robot 110 may retain an engagement with an assembly once keystone robot 110 has engaged base structure 126a.

As illustrated, assembly system 100 further includes robots 112a-d, 114a-d, 116a-d positioned in assembly cell 102, in addition to keystone robot 110. Assembly cell 102 may feature a radial architecture, in that robots 112a-d, 114a-d, 116a-d may be positioned in assembly cell 102 around a common point (e.g., keystone robot 110 and/or the center of assembly cell 102). For example, robots 112a-d, 114a-d, 116a-d may be arranged in at least two concentric circles (or other concentric polygons), with a first set of robots 112a-d, 114a-d positioned in a first configuration around a common point (e.g., keystone robot 110) and a second set of robots 116a-d positioned in a second configuration around the common point.

The architecture of assembly cell 102 (e.g., including spacing between robots 112a-d, 114a-d, 116a-d and positions of robots 112a-d, 114a-d, 116a-d) may be based on an average part to be assembled, such as a body-in-white (BIW) vehicle or a vehicle chassis, and/or may be based on the fixtureless assembly process of assembly system 100. For example, the layout of assembly cell 102 may be beneficial and/or may improve over a conventional assembly line in terms of assembly cycle time, cost, performance, robot utilization, and/or flexibility.

Within assembly cell 102, the robots may be variably spaced. Specifically, some robots 116a-d may be configured on a respective one of slides 118a-d, which may allow those robots 116a-d to change position (thereby changing robot spacing). That is, each of robots 116a-d on a respective one of slides 118a-d may move toward or away from keystone robot 110, e.g., allowing multiple different robot interactions for joining and/or adhesion.

Some robots 112a-d, 116a-d in assembly cell 102 may be similar to keystone robot 110 in that each includes a respective end effector configured to engage with structures, such as structures that may be connected with base structure 126a when retained by keystone robot 110. In some embodiments, robots 112a-d, 116a-d may be referred to with “assembly” and/or “material handling.”

In some embodiments, some robots 114a-d of assembly cell 102 may be used to effect a structural connection between structures. Such robots 114a-d may be referred to with “structural adhesive” or “adhesive.” The structural adhesive robots may be similar to keystone robot 110, except a tool may be included at the distal end of the robotic arm that is configured to apply structural adhesive to at least one surface of fixturelessly retained structures, e.g., either before or after the structures are positioned at joining proximities with respect to other structures for joining with the other structures. The joining proximity can be a position that allows a first structure to be joined to a second structure. For example, in various embodiments, the first and second structures may be joined though the application of an adhesive while the structures are within the joining proximity and subsequent curing of the adhesive.

Potentially, the duration for structural adhesives to cure may be relatively long. If this is the case, the robots retaining the joined structures, for example, might have to hold the structures at the joining proximity for an appreciable duration in order for the structures to be joined by the structural adhesive once it finally cures. This would prevent the robots from being used for other tasks, such as continuing to pick up and assemble structures, for a long time while the structural adhesive cures. In order to allow more efficient use of the robots, for example, in various embodiments a quick-cure adhesive may be additionally used to join the structures quickly and retain the structures so that the structural adhesive can cure without requiring both robots to hold the structures in place.

In this regard, some robots 114a-d, 116a-d in assembly cell 102 may be used to apply quick-cure adhesive and/or to cure the quick-cure adhesive. In some embodiments, a quick-cure UV adhesive may be used, and the robots may be referred to with “UV.” The UV robots may be similar to keystone robot 110, except a tool may be included at the distal end of the robotic arm that is configured to apply a quick-cure UV adhesive and/or cure the adhesive, e.g., when one structure is positioned within the joining proximity with respect to another structure. For example, the UV robots may include a respective tool configured to apply UV adhesive and to emit UV light to cure the UV adhesive. In effect, the UV robots may cure an adhesive after the adhesive is applied to one or both structures when the structures are within the joining proximity.

In some embodiments, the quick-cure adhesive applied by a UV robot may provide a partial adhesive bond in that the adhesive may retain the relative positions of structures within a joining proximity until the structural adhesive may be applied and/or cured to permanently join the structures. After the structural adhesive permanently joins the structures, the adhesive providing the partial adhesive bond may be removed (e.g., as with temporary adhesives) or may not be removed (e.g., as with complementary adhesives).

In contrast to various other assembly systems that may include a positioner and/or fixture table, described above, the use of a curable adhesive (e.g., quick-cure adhesive) may provide a partial adhesive bond that provides a way to retain the first and second structures during the joining process without the use of fixtures. The partial adhesive bond may provide one way to replace various fixtures that would otherwise be employed for engagement and retention of structures in an assembly system that, for example, uses a positioner and/or fixture table. Another potential benefit of fixtureless assembly, particularly using a curable adhesive, is improved access to various structures of a structural assembly in comparison with the use of fixtures and/or other part-retention tools, which inherently occlude access to sections of the structures to which they are attached.

Moreover, at least partially replacing fixtures and/or other part-retention tools with curable adhesives may provide a more reliable connection at one or more locations on a structural assembly in need of support—particularly where such locations in need of support are rendered nearly or entirely inaccessible by the fixtures and/or other part-retention tools. In addition, at least partially replacing fixtures and/or other part-retention tools with curable adhesives may provide the ability to add more structures to a structural assembly before application of a (permanent) structural adhesive—particularly where fixtures and/or other part-retention tools would hinder access for joining additional structures.

In various embodiments, some robots 114a-d, 116a-d may be used for multiple different roles. For example, robots 114a-d may perform the roles of a structural adhesive robot and a UV robot. In this regard, each of robots 114a-d may be referred to as a “structural adhesive/UV robot.” Each of structural adhesive/UV robots 114a-d may offer functionality of a structural adhesive robot when configured with a tool to apply structural adhesive, but may offer functionality of a UV robot when configured with a tool to apply and/or cure quick-cure adhesive. Structural adhesive/UV robots 114a-d may be configured to switch between tools and/or reconfigure a tool in order to perform the relevant task during assembly operations.

Similarly, robots 116a-d may perform the roles of a material handling robot and a UV robot. Accordingly, each of robots 116a-d may be referred to as a “material handling/UV robot.” Each of material handling/UV robots 116a-d may provide the functionality of a material handling robot when configured with an end effector for fixtureless retention of a structure, and may also provide the functionality of a UV robot when configured with a tool to apply and/or cure quick-cure adhesive. As with structural adhesive/UV robots 114a-d, material handling/UV robots 116a-d may be configured to switch between tools and/or reconfigure a tool in order to perform different operations at different times.

In assembly system 100, at least one surface of a structure to which adhesive is to be applied may be determined based on gravity and/or other forces that cause loads to be applied on various structures and/or connections of the assembly. Finite element method (FEM) analyses may be used to determine the at least one surface of the structure, as well as one or more discrete areas on the at least one surface, to which the adhesive is to be applied. For example, FEM analyses may indicate one or more connections of a structural assembly that may be unlikely or unable to support sections of the structural assembly disposed about the one or more connections.

In assembling at least a portion of a vehicle in assembly cell 102, one structure may be joined directly to another structure by directing the various robots 112a-d, 114a-d, 116a-d, as described herein. However, additional structures may be indirectly joined to one structure. For example, one structure may be directly joined to another structure through movement(s) of material handling robots 112a-d, structural adhesive/UV robots 114a-d, and material handling/UV robots 116a-d. Thereafter, one structure may be indirectly joined to an additional structure as the additional structure is directly joined to the other structure, for example, through movement(s) that additionally include keystone robot 110. Thus, structures may evolve throughout an assembly process as additional structures are directly or indirectly joined to it.

In some embodiments, robots 112a-d, 114a-d, 116a-d may fixturelessly join two or more structures together, e.g., with a partial, quick-cure adhesive bond, before fixturelessly joining those two or more structures with a structure(s) retained by keystone robot 110. The two or more structures that are joined to one another prior to being joined with base structure 126a may also be a structure, and may further be referred to as a “subassembly.” Accordingly, when a structure forms a portion of a structural subassembly that is connected with base structure 126a through movements of one or more robots 110, 112a-d, 114a-d, 116a-d, a structure of the structural subassembly may be indirectly connected to base structure 126a when the structural subassembly is joined to base structure 126a.

In some embodiments, the structural adhesive may be applied (e.g., deposited in a groove of one of the structures) before two structures are brought within the joining proximity. For example, one of structural adhesive/UV robots 114a-d may include a dispenser for dispensing a structural adhesive, and may apply the structural adhesive prior to the structures being brought within the joining proximity.

In some other embodiments, a structural adhesive may be applied after a structural assembly is fully constructed. For example, the structural adhesive may be applied to one or more joints or other connections between structures. The structural adhesive may be applied at a time after the last adhesive curing is performed. In some embodiments, the structural adhesive may be applied separately from assembly system 100.

After the assembly is complete (e.g., after all of the structures have been joined, retained with a partial adhesive bond, and with structural adhesive having been applied), the structural adhesive may be cured. Upon curing the structural adhesive, the portion of the vehicle may be completed and, therefore, may be suitable for use in the vehicle. For example, the assembly may be a body-in-white (BIW) vehicle. A completed structural assembly may meet any applicable industry and/or safety standards defined for consumer and/or commercial vehicles. In some embodiments, the adhesive applied to achieve the partial adhesive bond for retaining structures may be removed, for example, after the structural adhesive is cured. In some other embodiments, the adhesive for the partial adhesive bond may be left attached to the structures.

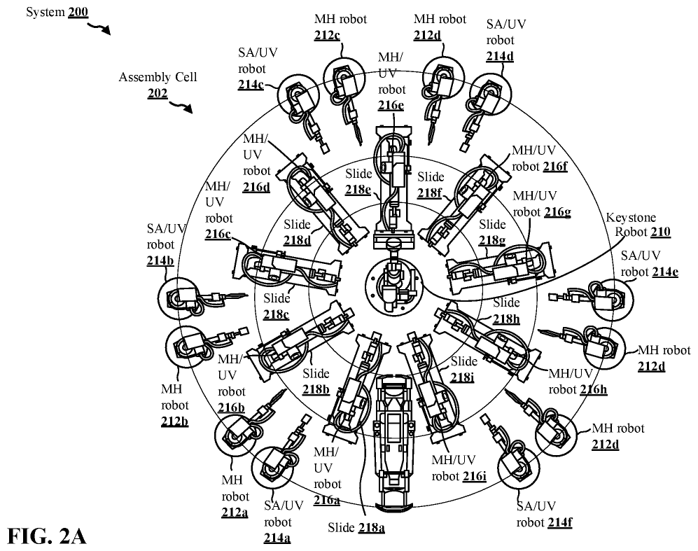

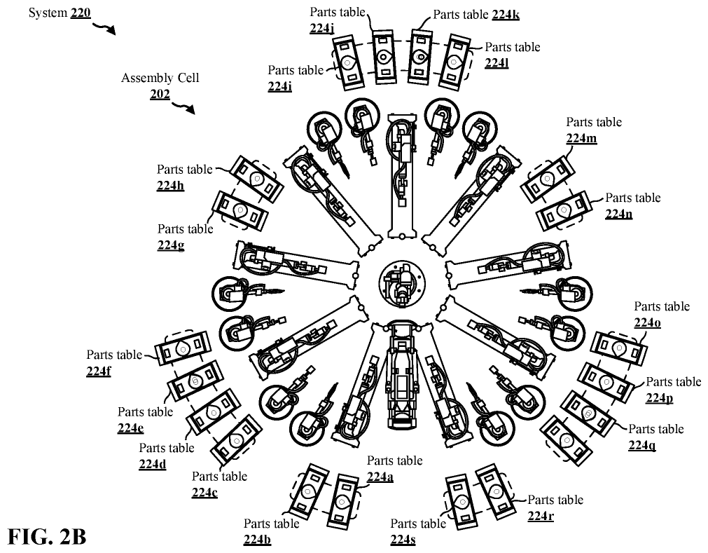

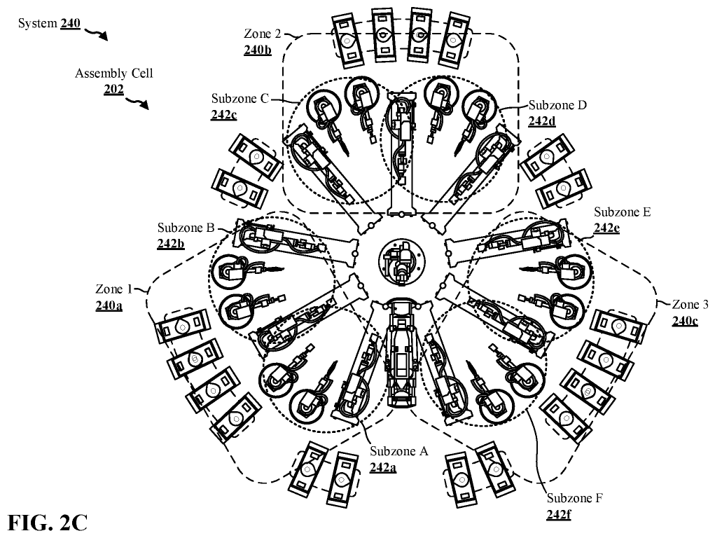

FIG. 2A illustrates an exemplary assembly system 200 including an assembly cell 202, according to various embodiments of the present disclosure. In some embodiments, assembly cell 202 may have dimensions of approximately 15 meters (m) in length by 15 m in width; however, other dimensions are possible without departing from the scope of the present disclosure.

In assembly cell 202, a keystone robot 210 may be positioned at an approximate center point, and may serve as a common point in assembly cell 202. Robots in assembly cell 202 may be positioned in different configurations relative to the common point or keystone robot 110.

For example, a plurality of first robots 212a-f, 214a-f may be positioned around a common point in a first configuration, and a plurality of second robots 216a-i may be positioned around the common point in a second configuration. The second configuration may be closer to the common point than the first configuration. For example, the plurality of first robots 212a-f, 214a-f may be arranged along the perimeter of a first shape, such as a circle or a polygon, whereas the plurality of second robots 216a-i may be arranged along the perimeter of a second shape, such as a concentric circle or concentric polygon.

In some embodiments, the first shape may be a circle having a radius of approximately 6.5 m, and the second shape may be a concentric circle having a radius of approximately 2.5 m to 4 m (e.g., depending upon the position of the plurality of second robots 216a-i). In some other embodiments, at least one of the first shape and/or the second shape may be a triangle, a quadrilateral, a pentagon, a hexagon, a heptagon, or an octagon.

In the first configuration, the plurality of first robots 212a-f, 214a-f may be approximately equidistant from the common point. In the second configuration, the plurality of second robots 216a-i may be approximately equidistant from the common point. Potentially, the plurality of first robots 212a-f, 214a-f may be equidistantly positioned along the perimeter of the first shape and/or the plurality of second robots 216a-i may be equidistantly positioned along the perimeter of the second shape (although not necessarily).

In some embodiments, each of the plurality of first robots 212a-f, 214a-f may be fixedly positioned in the first configuration. For example, each of the plurality of first robots 212a-f, 214a-f may be secured or fastened to a floor or other surface of assembly cell 202. In some other embodiments, each of the plurality of second robots 216a-i may be fixedly positioned in the second configuration.

However, one of the plurality of first robots 212a-f, 214a-f or the plurality of second robots 216a-i may be configured to translate towards and away from the common point to interact with the other of the plurality of first robots 212a-f, 214a-f or the plurality of second robots 216a-i. In the illustrated example, each of the plurality of second robots 216a-i may be configured to translate towards and away from the common point to interact with the plurality of first robots 212a-f, 214a-f. To do so, each of the plurality of second robots 216a-i may be positioned on a respective slide 218a-i or other track, each of which may be controlled to cause a respective one of the plurality of second robots 216a-i to translate towards and away from the common point to interact with a subset of the plurality of first robots 212a-f, 214a-f.

Each of slides 218a-i may have a length of approximately 1.5 m. When positioned on slides 218a-i, the distance between any two of plurality of second robots 216a-i may be approximately at least 1.8 m, which may allow the chassis of a car to move between robots. However, when positioned at the furthest points on slides 218a-i (i.e., closest to the plurality of first robots 212a-f, 214a-f and furthest from keystone robot 210), the distance between any two of plurality of second robots 216a-i may be approximately greater than 1.8 m, which may allow larger objects (e.g., larger vehicle chasses) to clear the robots.

In some embodiments, the plurality of first robots 212a-f, 214a-f may include both material handling (MH) robots 212a-f and structural adhesive (SA)/UV robots 214a-f. In assembly cell 202, the number of material handling robots 212a-f may be equal to the number of structural adhesive/UV robots 214a-f. Potentially, material handling robots 212a-f may alternatingly arranged with structural adhesive/UV robots 214a-f in the first configuration (although not necessarily).

As described above, material handling robots 212a-f may be configured to pick up (e.g., engage and retain) and join structures (e.g., parts). Structural adhesive (SA)/UV robots 214a-f, however, may be configured to apply structural adhesive to at least one surface of at least one structure to be joined with another structure and, additionally, may be configured to apply and cure a quick-cure (e.g., UV) adhesive. For example, each of structural adhesive/UV robots 214a-f may be configured to switch from a tool for dispensing structural adhesive to a tool for curing (e.g., a UV tool) while a proximate one of material handling robots 212a-f and/or a proximate one of material handling/UV robots 216a-i is applying an MMC procedure to fixturelessly join structures during the assembly process.

The plurality of second robots 216a-i may include material handling/UV robots. As with material handling robots 212a-f of the plurality of first robots, each of material handling/UV robots 216a-i may be configured to pick up and join structures (e.g., parts). Material handling/UV robots 216a-i may be further configured to apply and cure a quick-cure (e.g., UV) adhesive to at least one surface of at least one structure to be joined with another structure. In some embodiments, each of material handling/UV robots 216a-i may be configured to switch between a material-handling end effector and a curing (e.g., UV) tool based on structures being joined.

Further to FIG. 2A, FIG. 2B shows an exemplary assembly system 220 including assembly cell 202, according to various embodiments of the present disclosure. In assembly system 220, a plurality of parts tables 224a-s are included. Each of parts tables 224a-s may be included in assembly cell 202 or may be positioned around a perimeter or outer boundary of assembly cell 202.

Each of parts tables 224a-s may be a respective location at which a set of structures to be used in the assembly process (e.g., joined) is held or arranged. Thus, each of material handling robots 212a-f and each of material handling/UV robots 216a-i may be able to reach structures located on at least one of parts tables 224a-s. For example, each of material handling/UV robots 216a-i may be able to reach structures located on at least one of parts tables 224a-s by varying its position along a respective one of slides 218a-i.

Each of parts tables 224a-s may be modular and/or moveable, e.g., so that structures can be reloaded on the parts tables. As parts tables 224a-s may be radially positioned along the perimeter of assembly cell 202, reloading can occur with minimal or no interruption to operations by the robots. In some embodiments, an automated guided vehicle (AGV) may be configured to move each of parts tables 224a-s away from assembly cell 202 in order to be reloaded with additional structures that will be used as the assembly process progresses. For example, an AGV may transport one of parts tables 224a-s away from assembly cell 202 to a point at which it may be reloaded once it is empty (i.e., once the robots have picked up and removed every structure originally held thereon). Once that one of parts tables 224a-s has been reloaded with structures, an AGV may return it to a respective position relative to assembly cell 202 at which at least one of material handling robots 212a-f and/or at least one of material handling/UV robots 216a-i is able to reach structures located thereon. In some embodiments, a plurality of AGVs may be simultaneously operable so that a plurality of parts tables 224a-s may be simultaneously (or at least contemporaneously) reloaded.

In some embodiments, each of material handling robots 212a-f and each of material handling/UV robots 216a-i may be able to reach structures located on at least two parts tables 224a-s, which may reduce the time commensurate with the assembly process. For example, as further described below, one of material handling robots 212a-f and one of material handling/UV robots 216a-i may pick up and join structures located on one of parts tables 224a-s until that one of parts tables 224a-s is empty. Once that parts table is empty, the one of material handling robots 212a-f and the one of material handling/UV robots 216a-i may pick up and join structures located on a neighboring one of parts tables 224a-s. That one of parts tables 224a-s may be moved by an AGV to be reloaded and returned to its position relative to assembly cell 202 while the robots are picking structures at the neighboring one of parts tables 224a-s. In effect, a continuous assembly process may be achieved in this way, as idle time conventionally commensurate with reloading parts for use may be reduced or eliminated.

FIG. 2C shows an exemplary assembly system 240 including assembly cell 202, according to various embodiments of the present disclosure. According to assembly system 240, assembly cell 202 may be configured as a plurality of zones 240a-c. For example, assembly cell 202 may be divided into three discrete zones; however, more or fewer zones are also possible without departing from the scope of the present disclosure.

According to various embodiments, the plurality of first robots 212a-f, 214a-f and the plurality of second robots 216a-i may be divided within separate zones 240a-c for simultaneously performing various assembly operations, such as joining structures to form subassemblies, which then may be provided to keystone robot 210. While robots within one of zones 240a-c may interact to perform various assembly operations, one or more of the plurality of second robots 216a-i may be configured to translate across separate zones (or one or more of the plurality of first robots 212a-f, 214a-f, if configured on a slide for translation).

In some embodiments, each of zones 240a-c may include at least two subzones. For example, zone 1 240a may include subzone A 242a and subzone B 242b, zone 2 240b may include subzone C 242c and subzone D 242d, and zone 3 may include subzone E 242e and subzone F 242f Each subzone 242a-f may include a respective one of material handling robots 212a-f, a respective one of structural adhesive/UV robots 214a-f, and one of material handling/UV robots 216a-i. In addition, the subzones within zones 240a-c may “share” another one of material handling/UV robots 216a-i. Having some material handling/UV robots 216a-i interact with some other robots across different subzones may improve some assembly operations (e.g., joining and geometry) and assembly time, e.g., as two UV robots may be available for each join.

As described in further detail below, this architecture in which an assembly cell is divided into a plurality (e.g., three) of zones that each include a respective plurality (e.g., two) of subzones allows for parallel and simultaneous assembly operations. Further, some robots are still able to reach, access, and/or interact with other robots to combine subassemblies into larger subassemblies, e.g., until the final subassembly is produced and retained by keystone robot 210.

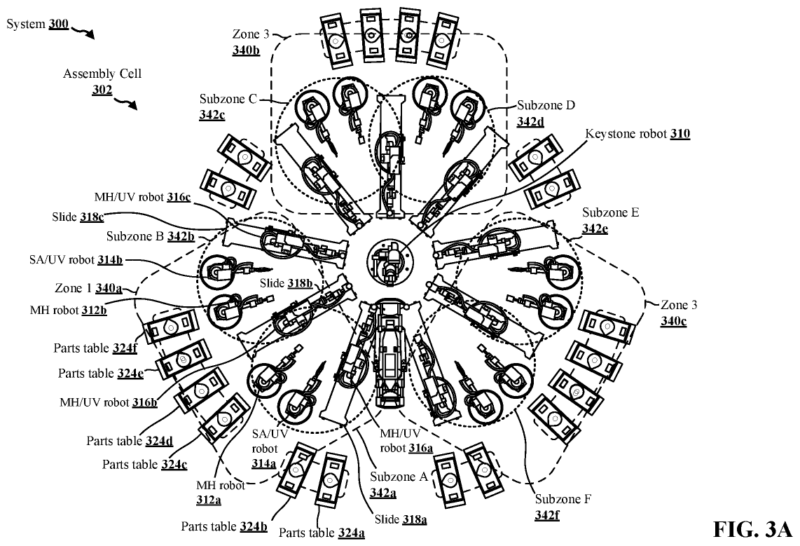

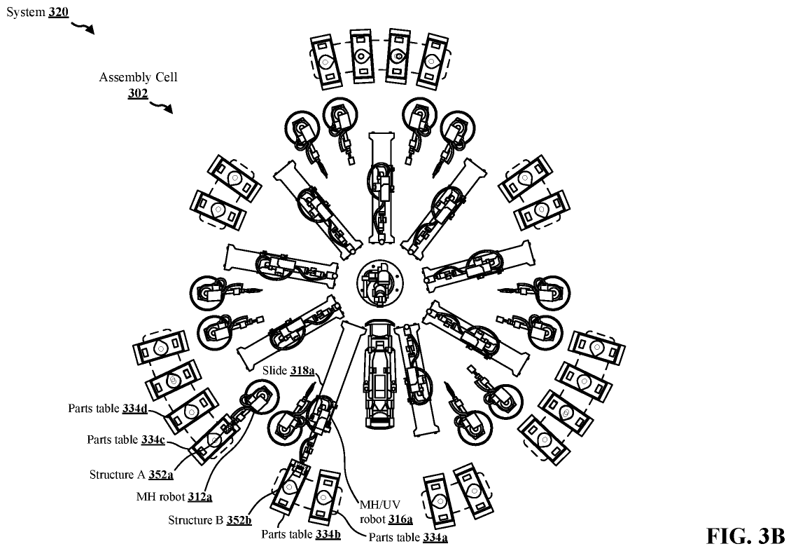

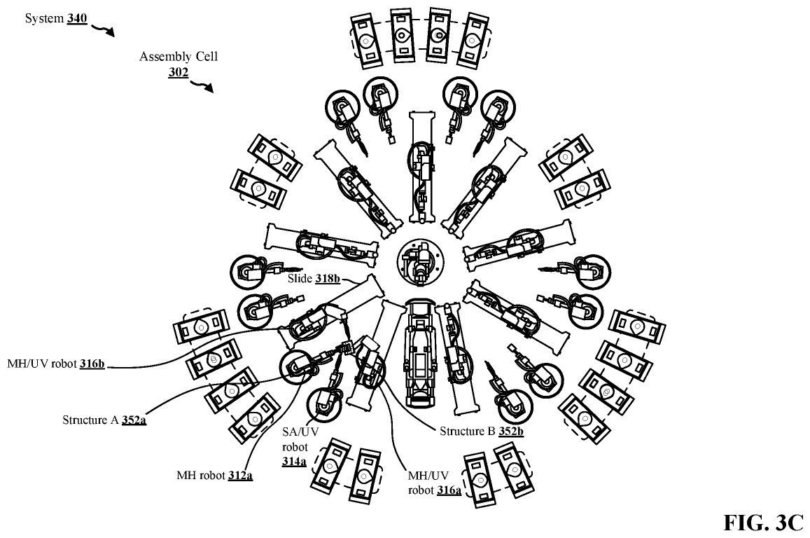

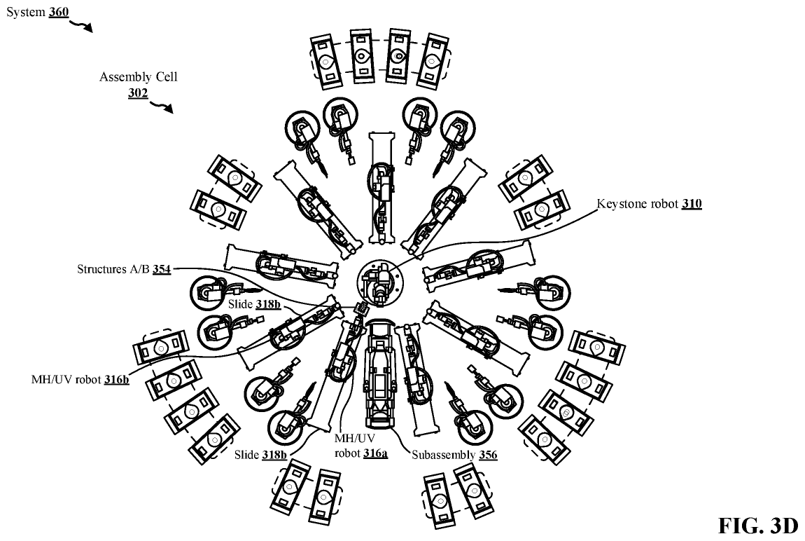

With reference to FIGS. 3A-3D, exemplary assembly operations in assembly systems are illustrated. The assembly systems include robots and parts tables arranged relative to an assembly cell 302, as described according to various embodiments of the present disclosure. In one assembly system 300, assembly cell 302 includes a plurality of first robots positioned around a common point in a first configuration, and a plurality of second robots positioned around the common point in a second configuration that is closer to the common point than the first configuration. The common point may be, for example, a keystone robot 310 that is positioned approximately at the center of assembly cell 302.

The plurality of first robots may include material handling robots structural adhesive/UV robots arranged along the perimeter of a first circle, whereas the plurality of second robots may include material handling/UV robots arranged along the perimeter of a second circle. The plurality of second robots may be configured to translate along a path (e.g., using a slide or other similar mechanism) towards and away from the first circle around which the plurality of first robots is arranged.

Assembly cell 302 may be divided into a plurality (e.g., three) of zones 340a-c, and each of zones 340a-c includes a respective plurality (e.g., two) subzones 342a-f. In some embodiments, each of subzones 342a-f may include two of the plurality of first robots and two of the plurality of second robots; however, one of the two second robots may be shared across subzones 342a-f or even across zones 340a-c. In each of the subzones 342a-f, one of the plurality of second robots may be diagonally opposed to one of the plurality of first robots and another of the plurality of second robots may be diagonally opposed to another of the plurality of first robots.

Illustratively, referring to an assembly system 300 of FIG. 3A, zone 1 340a of assembly cell 302 includes subzone A 342a in which a first material handling/UV robot 316a is diagonally opposed to a first material handling robot 312a that is fixedly positioned in assembly cell 302. Similarly, a second material handling/UV robot 316b is diagonally opposed to a first structural adhesive/UV robot 314a that is fixedly positioned in assembly cell 302.

However, second material handling/UV robot 316b may be shared across subzone A 342a and subzone B 342b of zone 1 340a, and therefore, second material handling/UV robot 316b may also be diagonally opposed to a second structural adhesive/UV robot 314b that is fixedly positioned in subzone B 342b. Also in subzone B 342b, a third material handling robot/UV robot 316c is diagonally opposed to a second material handling robot 312b that is fixedly positioned.

In effect, each of the subzones may include a dedicated material handling robot and a dedicated material handling/UV robot configured to join structures at an approximately diagonal angle, a dedicated structural adhesive robot that is able to function as a UV robot, and a “shared” material handling/UV robot. Such configurations in which robots are diagonally opposed to one another may facilitate two robots capable of UV curing (or otherwise quick curing) joined structures, which may reduce the duration commensurate with quick curing.

For assembly operations in an assembly system 320 shown in FIG. 3B, various material handling robots in each of subzones A-F 342a-f of zones 1-3 340a-c may “pick up” or engage a respective structure from one of the parts tables respectively accessible thereby. Referring to subzone A 342a of zone 1 340a as a representative example, first material handling robot 312a may pick up a structure A 352a from third parts table 334c, which first material handling robot 312a may be configured to access (and empty) before alternating to fourth parts table 334d. For example, first material handling robot 312a may use an end effector to engage and retain structure A 352a.

Similarly, first material handling/UV robot 316a may pick up a structure B 352b from second parts table 334b, which first material handling/UV robot 316a may be configured to access (and empty) before alternating to first parts table 334a. First material handling/UV robot 316a may be configured to switch between tools for material handling (e.g., engaging and retaining structures) and quick curing joined structures, and therefore, first material handling/UV robot 316a may be configured to switch to or activate an end effector in order to pick up structure B 352b.

Potentially, first material handling/UV robot 316a may be positioned in assembly cell 302 such that the distance to structure B 352b on second parts table 334b prohibits first material handling/UV robot 316a from engaging structure B 352b. Accordingly, first material handling/UV robot 316a may be configured to change position in assembly cell 302 in order to reduce the distance to second parts table 334b. For example, first material handling/UV robot 316a may use a first slide 318a to traverse a line within assembly cell 302, and first material handling/UV robot 316a may travel on first slide 318a toward the perimeter of assembly cell 302 so the first material handling/UV robot 316a is able to access structures on the parts tables.

In some embodiments, first structural adhesive/UV robot 314a may be configured to switch to or activate a tool for dispensing structural adhesive. First structural adhesive/UV robot 314a may apply structural adhesive to one or more surfaces of at least one of structure A 352a and/or structure B 352b, e.g., once retained by first material handling robot 312a and/or first material handling/UV robot 316a, respectively.

Now with respect to an assembly system 340 shown in FIG. 3C, structure A 352a and structure B 352b may be joined by one or both of the material handling robots. That is, one or both of first material handling robot 312a and/or first material handling/UV robot 316a may bring structure A 352a and/or structure B 352b, respectively, to a joining proximity at which the structures can be joined. In so doing, an MMC procedure may be performed.

For example, one of the material handling robots may move its respectively retained structure into a position at which the two structures can be joined, and then one or more measurements may be determined that are indicative of a difference between the actual position of the structures and the joining proximity at which the structures are able to be joined (e.g., within some acceptable tolerances). The measurements are then used to determine (e.g., calculate) one or more corrective movements of one or both of the material handling robots. The corrective movements are then applied to the appropriate one or both of the material handling robots in order to bring the structures within the joining proximity at which the structures can be joined.

In some embodiments, when the MMC procedure is performed, first structural adhesive/UV robot 314a may switch to or active a quick curing (e.g., UV) tool from the structural adhesive dispensing tool. In switching tools during the period in which structures are joined, the structural adhesive/UV robots may reduce the amount of lost or idle time experienced by the robots in assembly cell 302.

Once structure A 352a and structure B are satisfactorily joined by the material handling robots, first structural adhesive/UV robot 314a may apply UV for quick curing the bond between the structures. Potentially, the “shared” material handling/UV robot may accelerate the quick curing process. For example, second material handling/UV robot 316b may be configured to switch to or activate a quick curing (e.g., UV) tool, and may apply UV to quickly bond structure A 352a and structure B 352b, e.g., contemporaneously with first structural adhesive/UV robot 314a.

In some embodiments, second material handling/UV robot 316b may traverse a line within assembly cell 302 in order to reach a position at which second material handling/UV robot 316b is able to apply UV for quick curing. For example, second material handling/UV robot 316b may use second slide 318b to travel to a point at which it is able to direct its quick curing tool toward the point at which the structures are joined.

Referring to an assembly system 360 shown in FIG. 3D, structure A 352a and structure B 352b may be satisfactorily temporarily bonded. Accordingly, one of the material handling robots may release its respectively retained structure, and the other of the material handling robots may retain the joined structures. For example, first material handling robot 312a may release structure A 352a once the quick curing is completed, and first material handling/UV robot 316a may retain a joined structure A/B 354.

First material handling/UV robot 316a may subsequently bring joined structure A/B 354 to keystone robot 310 to be joined with a subassembly 356. For example, first material handling/UV robot 316a may use first slide 318a to traverse a line toward keystone robot 310 in assembly cell 302. When first material handling/UV robot 316a arrives at an appropriate location, first material handling/UV robot 316a may bring joined structure A/B 354 to a position at which it can be joined with subassembly 356 by keystone robot 310. For example, first material handling/UV robot 316a may position joined structure A/B 354 on a tray or other staging area at keystone robot 310 at which operations for subassembly 356 may be performed.

Potentially, second material handling/UV robot 316b may use second slide 318b to traverse a line toward keystone robot 310 in assembly cell 302. When a suitable position is reached, second material handling/UV robot 316b may facilitate operations for subassembly 356. For example, second material handling/UV robot 316b may apply UV for quick curing when joined structure A/B 354 is joined with subassembly 356 at keystone robot 310.

In various embodiments, other similar operations may be performed by the robots in each subzone of the zones. Thus, structures may be joined and subsequently delivered to keystone robot 310. Subassembly 356 may then be constructed at keystone robot 310 through receiving various joined structures from robots included in each of the subzones of the zones. Once subassembly 356 is completed, material handling/UV robots may use respective slides to traverse lines in assembly cell 302 away from keystone robot 310 in order to increase the space available to remove subassembly 356 from assembly cell 302.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A manufacturing cell for assembling a structure, comprising:
a plurality of first robots positioned around a common point in a first configuration; and
a plurality of second robots positioned around the common point in a second configuration, the second configuration being closer to the common point than the first configuration;
wherein one of the plurality of first robots is configured to translate towards and away from the common point to interact with one of the plurality of second robots or one of the plurality of second robots is configured to translate towards and away from the common point to interact with one of the plurality of first robots.

2. The manufacturing cell of claim 1, wherein at least the plurality of first robots are equidistant from the common point in the first configuration or at least the plurality of second robots are equidistant from the common point in the second configuration.

3. The manufacturing cell of claim 1, wherein the plurality of first robots are fixedly positioned in the first configuration when the plurality of second robots translate towards and away from the common point, or the plurality of second robots are fixedly positioned in the second configuration when the plurality of first robots translate towards and away from the common point.

4. The manufacturing cell of claim 1,
wherein the plurality of first robots comprise a material handling robot configured to pick and join parts of a structure and an adhesive dispensing and curing robot configured to adhere the parts together; and
wherein the plurality of second robots comprise a material handling and curing robot configured to pick, join, and adhere parts together to form subassemblies when assembling the structure.

5. The manufacturing cell of claim 4, further comprising a central robot located at the common point and configured to receive the subassemblies from the plurality of second robots.

6. The manufacturing cell of claim 4, wherein the plurality of first robots and the plurality of second robots are divided within separate zones for simultaneously assembling different parts to form the subassemblies.

7. The manufacturing cell of claim 6, wherein one of the plurality of first robots or one of the plurality of second robots is configured to translate across the separate zones.

8. The manufacturing cell of claim 6,
wherein each zone comprises a first subzone and a second subzone;
wherein the plurality of second robots comprises a material handling robot and a curing robot;
wherein the material handling robot is diagonally opposed to one of the plurality of first robots within either the first subzone or the second subzone; and
wherein the curing robot is diagonally opposed to another of the plurality of first robots within both the first subzone and the second subzone.

9. The manufacturing cell of claim 4, wherein the plurality of first robots comprise a plurality of material handling robots and a plurality of adhesive dispensing and curing robots, and wherein the plurality of material handling robots and the plurality of adhesive dispensing and curing robots are alternately arranged in the first configuration.

10. The manufacturing cell of claim 4, wherein the adhesive dispensing and curing robot is configured to switch from an adhesive end-effector to a curing end-effector while the material handling robot is applying a move-measure-correct procedure.

11. The manufacturing cell of claim 4, wherein the material handling and curing robot is configured to switch between a material handling end-effector and a curing end-effector based on the subassemblies being assembled.

12. The manufacturing cell of claim 4, further comprising:
one or more pairs of part tables movably positioned at a perimeter of the manufacturing cell for access by the material handling robot and the material handling and curing robot;
wherein one table in each pair is accessible for the parts while the other table in each pair is being reloaded with different parts.

13. A manufacturing cell for assembling a structure, comprising:
a first set of robots arranged along a perimeter of a first shape; and
a second set of robots arranged along a perimeter of a second shape within the first shape,
wherein at least one of the robots of the first set of robots is configured to translate along a first path towards and away from the second shape or at least one of the robots of the second set of robots is configured to translate along a second path towards and away from the first shape.

14. The manufacturing cell of claim 13, wherein the first shape or the second shape is a polygon comprising one of a triangle, a quadrilateral, a pentagon, a hexagon, a heptagon, or an octagon.

15. The manufacturing cell of claim 13, wherein at least the first set of robots are equidistantly positioned along the perimeter of the first shape or at least the second set of robots are equidistantly positioned along the perimeter of the second shape.

16. The manufacturing cell of claim 13, wherein the first set of robots are fixedly positioned along the perimeter of the first shape when the second set of robots translate along the second path, or the second set of robots are fixedly positioned along the perimeter of the second shape when the first set of robots translate along the first path.

17. The manufacturing cell of claim 13,
wherein the first set of robots comprise a material handling robot configured to pick and join parts of a structure and an adhesive dispensing and curing robot configured to adhere the parts together; and
wherein the second set of robots comprise a material handling and curing robot configured to pick, join, and adhere parts together to form subassemblies when assembling the structure.

18. The manufacturing cell of claim 17, further comprising a central robot located within the second shape and configured to receive the subassemblies from the second set of robots.

19. A manufacturing cell for assembling a structure, comprising:
a first set of robots arranged along a perimeter of a first shape;
a second set of robots arranged along a perimeter of a second shape within the first shape; and
a central robot located within the second shape for receiving subassemblies from the second set of robots;
wherein at least one of the robots of the first set of robots is configured to translate along a first path towards and away from the second shape or at least one of the robots of the second set of robots is configured to translate along a second path towards and away from the first shape.

20. The manufacturing cell of claim 19, wherein the first shape or the second shape is a polygon comprising one of a triangle, a quadrilateral, a pentagon, a hexagon, a heptagon, or an octagon.
